(19) United States
(12) Patent Application Publication
(10) Pub. No.: US 2005/0008434 A1
(43) Pub. Date: Jan. 13, 2005

(54) Roadway projecting marker

(76) Inventor: Shin-Min Chen, Taiwan (CN)

Correspondence Address: Venable Baetjer Howard & Civiletti, 575 7th Street N W, Washington, DC, 20004, US

(21) Appl. No.: 10/492,326

(22) PCT Filed: Oct. 15, 2001
(86) PCT No.: PCT/CN01/01480

(51) Int. Cl. G08B 1/00

(52) U.S. Cl. 404/16

(57) ABSTRACT

A speed bump assembly on a road surface provides a sign to a driver to slow down a car and a warning effect to the driver. The speed bump has a tapered structure and has recesses, grooves or holes defined in opposite sides to enhance shock-absorbing, noise-absorbing and nonskid. Two reflection tabs are attached respective to the opposite sides of the speed bump to provide a warning and reflective effect to a driver to draw the driver's attention when driving. A metal base is attached to the bottom of the speed bump to keep the plastic speed bump from deforming due to expansion when hot and shrinking when cold and to enhance the strength of combination between the road surface.

This application is the National Stage of international application No. PCT/CN01/01480, filed on Oct. 15, 2001.

### BACKGROUND OF THE INVENTION

1. Field of the Invention

The present invention relates to a speed bump assembly, and more particularly to a speed bump assembly mounted on a road surface and on division lines to provide a sign to a driver to slow down a car and to call the driver's attention to safety in driving.

2. Description of Related Art

Traffic accidents are always one of the top 10 reasons for death in many countries and easily occur when a driver exceeds the speed limit or dozes off. Traffic accidents are an economic loss to society and will cause sorrow for the driver's family.

However, to call driver's attention and improve driving safety, speed bumps are mounted at intersections or merges to superhighways. In addition, protrusions are always mounted on division lines on road surfaces to warn drivers to notice road conditions or lane changes to prevent accidents.

A common way to draw a driver's attention to the condition of the road condition and to slow down the speed is to arrange multiple protrusions in a row on the road surface that are made of concrete, asphalt, paint or plastic and have plastic or aluminum reflection tabs. With a rough surface provided with a reflective effect on the road, the speed bump device on the road will cause vibrations and a reflection to provide a warning effect to the driver.

However, each aforementioned conventional technique has a specific disadvantage that causes danger to a driver or a pedestrian. For example, the concrete speed bump device will break up after long-term use or being run over by vehicles. The concrete pieces may be thrown up by the wheels of a vehicle when the vehicle run over the broken concrete speed bump device at a high speed and strike windshield of another car or a pedestrian. This will shock the driver in the car struck and cause an accident.

The asphalt and painted speed bumps are easily softened high ambient temperature, and the warning effect of the speed bump device will be lost. In addition, the paint will give off volatile toxic gas due to high ambient temperature and seriously influence the environment and people's health.

The conventional plastic speed bump easily deforms, deteriorates or breaks into pieces due to the high ambient temperature, and the plastic reflection tab will detach from the speed bump and be another hazard to the driver.

The conventional plastic speed bump has a smooth surface and does not provide good friction, so the vehicle easily slips when the driver changes lanes. In addition, huge vibrations and loud noise will occur when the wheels of vehicles strike the aluminum reflection tab, which will damage wheels and cause accidents.

Furthermore, to repair the damaged conventional speed bumps is labor intensive. The material used to repair the damaged speed bump device will not match the deteriorated material of the damaged speed bump and easily detaches from the deteriorated material. In addition, the conventional speed bump does not provide an excellent noise-absorbing effect, such that loud noise will occur when vehicles passes through the speed bump.

### OBJECTIVES OF THE INVENTION

The main objective of the invention is to provide a speed bump assembly to increase drivers' alertness and to draw the drivers' attention to the condition of the road by means of the protruding speed bump assembly.

A further objective of the invention is to provide a speed bump assembly to make the driver quickly aware of the condition of the road by means of reflected light.

Another objective of the invention is to provide a speed bump assembly that is useful and will not cause toxic material to damage the environment and people's health over long term use.

Another objective of the invention is to provide a speed bump assembly that can reduce noise.

Another objective of the invention is to provide a speed bump assembly that can keep vehicles from slipping to improve the driving safety.

### SUMMARY OF THE INVENTION

This invention provides a speed bump assembly on a road surface comprising a speed bump on the road surface and having an tapered structure and multiple sides with recesses, grooves, reflection tabs and a driving hole;

a metal base attached to the bottom of the speed bump and having a bottom with a metal stub;

a reflective feature attached to the speed bump to reflect light to provide a warning effect to a driver,

wherein the speed bump assembly is composed of the speed bump, the metal base and the reflection feature to provide a warning effect to a driver by means of vibration caused by impact between the speed bump and wheels on a vehicle when the vehicle passes through an intersection of a road or crosses division lines so as to improve driving safety.

The speed bump is made of any possible material.

The speed bump is made of plastic material.

The metal base is made of any possible metal.

The metal base is made of plastic steel to work with different thermal expansion coefficients at various locations.

The metal base has multiple metal stubs to work at different location.

Each stub on the metal base has an outer surface has at least one metal rib to increase the strength of the joint between the metal stub and the road surface.

The reflective feature is made of any possible material.

The reflective feature reflects light to provide a reflective effect and is variable based on variations of the speed bump.

### BRIEF DESCRIPTION OF THE DRAWINGS

FIG. 1A is a perspective view of a first embodiment of a speed bump on a road surface in accordance with the present invention;

FIG. 1B is a perspective view of a second embodiment of a speed bump on a road surface in accordance with the present invention;

FIG. 2 is an exploded perspective view of the speed bump in FIG. 1;

FIG. 3 is an operational side view in partial section of a road surface with the speed bump in FIG. 1; and

FIG. 4 is a perspective view of a road surface with multiple speed bumps in accordance with the present invention; and

FIG. 5 is a perspective view of an intersection of a road with multiple third embodiments of speed bumps in accordance with the present invention.

### DETAILED DESCRIPTION OF PREFERRED EMBODIMENT

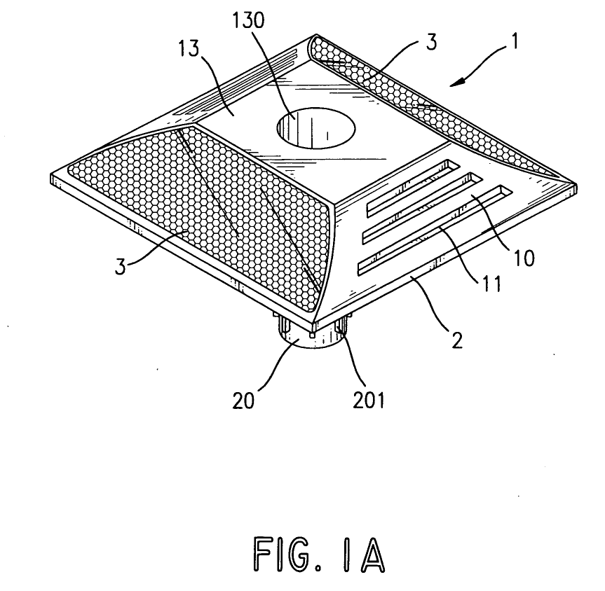

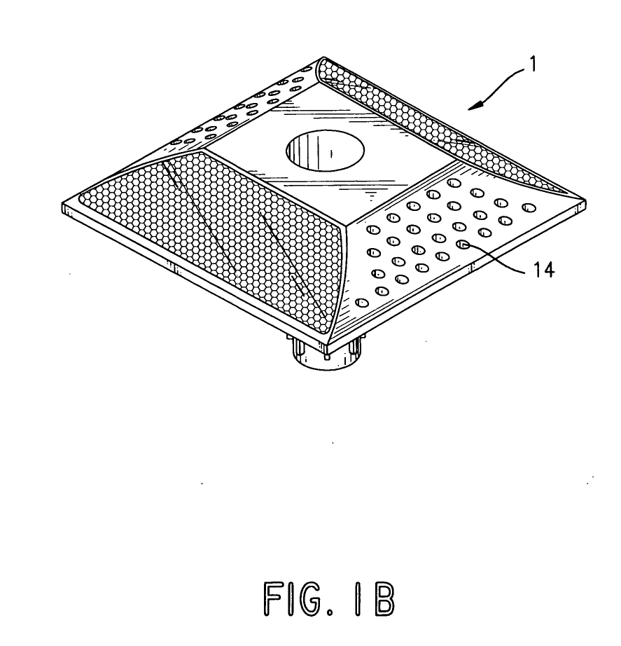

With reference to FIGS. 1A and 1B, a speed bump assembly on a road surface in accordance with the present invention comprises a speed bump (1). The speed bump (1) has a bottom attached to a metal base (2) to make the bottom of the speed bump (1) flush with the road surface to achieve a stable effect. The speed bump (1) has a tapered structure and has recesses (10) and grooves (11) defined in sides thereof, as shown in FIG. 1 or holes (14) defined in sides thereof, as shown in FIG. 1B.

The recesses (10), grooves (11) and holes (14) increase the shock and noise absorbing effect and save material during manufacturing. In addition, two engaging recesses (12) are defined respectively in opposite sides to receive reflection tabs (3) to provide a reflecting warn effect. The speed bump (1) has a flat top surface (13) with a driving hole (130) for a special design of the road surface. A cone-shaped object is inserted into the driving hole (130) to drive a metal stub (20) on the metal base (2) into the road surface, so the combination and stability between the speed bump assembly and the road surface is enhanced.

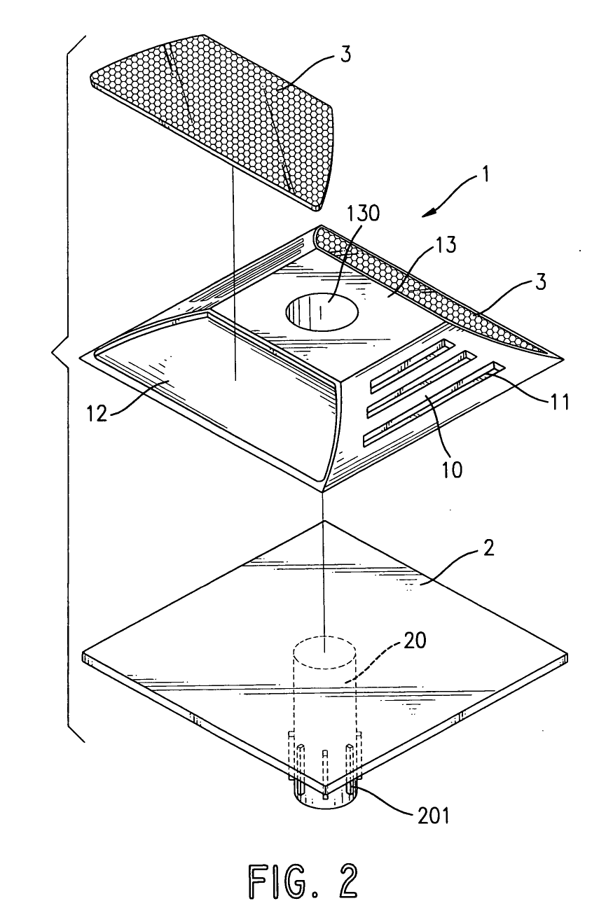

With reference to FIG. 2, a metal base (2) is mounted on the bottom of the speed bump (1). The metal base (2) has a bottom with a metal stub (20) to fit into a hole defined in the road surface to attach the speed bump (10) to the road. In addition, multiple ribs (201) are formed around the surface of the metal stub (20), and the metal stub (20) can securely engage the hole in the road surface by means of the ribs (201) so that a secure and tight combination effect is provided. The metal base can be bonded to the bottom of the speed bump with glue to provide an improved combination between the two. The reflection tabs (3) are received in the engaging recesses (12) in the speed bump (1). Each engaging recess (12) is a concave space for receiving and securely holding a reflection tab (3).

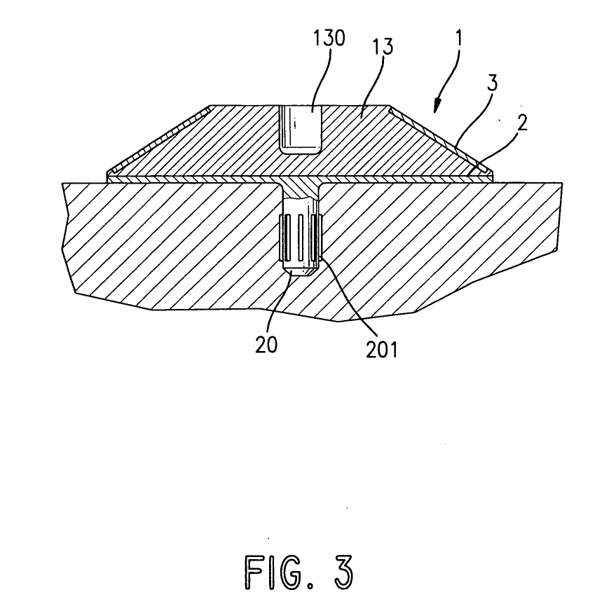

With reference to FIG. 3, a hole with a desired depth is defined in the road surface at a position where the metal stub (20) on the speed bump (1) is desired to be mounted. Glue is applied to the road surface and the bottom of the metal base (2), and the metal stub (20) on the speed bump (1) is then put into the preset hole in the road surface to securely mount the speed bump on the road surface.

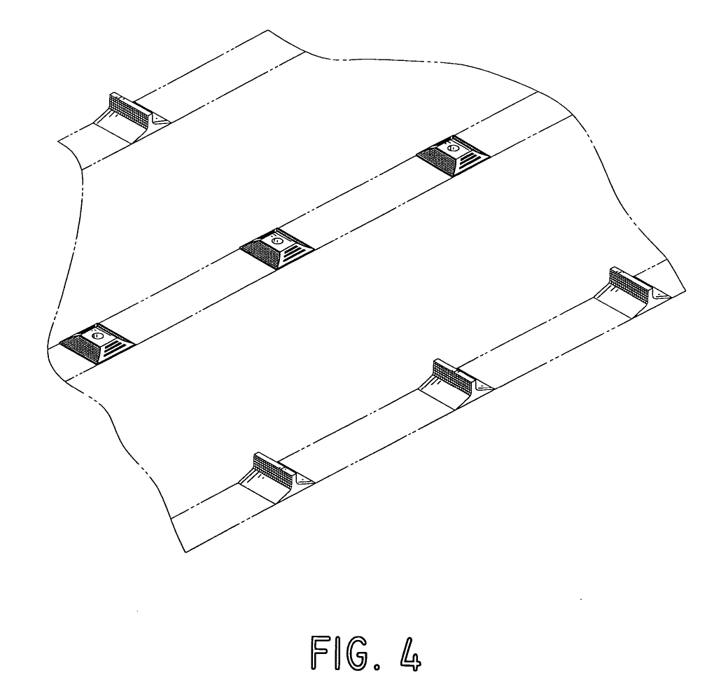

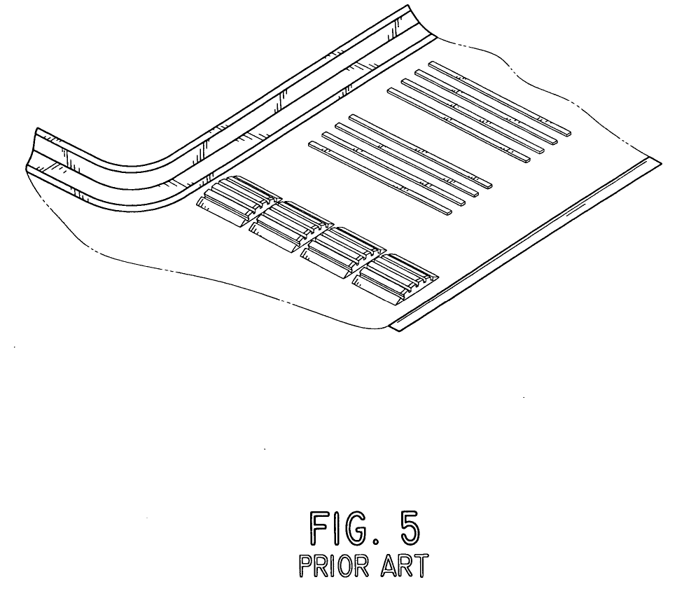

With reference to FIGS. 4 and 5, the speed bump can be mounted on the dividing lines or the intersection on the road. When a vehicle passes through the intersection of the road, the speed bump can provide a reflective effect to the driver and a vibration due to the protruding structure of the speed bump assembly. This can provide a warning effect to the driver to make the driver keep an eye on traffic safety so as to keep traffic accidents from occurring. In addition, with the arrangements of the recesses, grooves and holes in the surface of the speed bump, noise will be reduced when a vehicle passes through the speed bump assembly. The speed bump assembly in accordance with the present invention compared with the prior art has the following advantages.

1. Convenient to use. When the speed bump assembly is used with a concrete road, a hole is defined previously in the road at a position where the speed bump assembly is desired to be located. The bottom of the metal base on the speed bump is then coated with glue and is then mounted on the hole, such that the installation of the speed bump assembly is done. In addition, to mount the speed bump assembly on an asphalt road, the metal stub coated with glue is directly implanted into the road. In addition, to improve the combination between the speed bump assembly and the road surface, screws can be used to screw into the road surface.

2. Versatile in use. The speed bump assembly in accordance with the present invention can be used on a road surface or intersection of superhighways, urban roads, streets, lanes or alleyways. The speed bump assembly can be also used at schools or entrances for vehicles to provide a warning effect.

3. Easy replacement. Because the speed bump assembly is individually mounted on the road surface, only a damaged speed bump assembly must be replaced. The new speed bump can provide its desired function immediately and does not have a long delay time for solidifying such as concrete, asphalt and paint, and the time of traffic is obstructed when replacing the speed bump assembly is decreased.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A speed bump assembly on a road surface comprising:
a speed bump for being mounted on a road surface and having an tapered structure and multiple sides provided with recesses, grooves, reflection tabs and a driving hole;
a metal base attached to a bottom of the speed bump and having a bottom provided with a metal stub; and
a reflection feature attached to the speed bump for reflecting light to provide a warning effect to a driver,
wherein the speed bump assembly is composed of the speed bump, the metal base and the reflective feature to provide a warning effect to a driver by means of vibration occurring by impact between the speed bump and wheels on a vehicle when the vehicle passes through an intersection of a road or cross dividing lines so as to improve driving safety.

2. The speed bump assembly as claimed in claim 1, wherein the speed bump is made of any possible material.

3. The speed bump assembly as claimed in claim 2, wherein the speed bump is made of plastic material.

4. The speed bump assembly as claimed in claim 1, wherein the metal base is made of any possible metal.

5. The speed bump assembly as claimed in claim 4, wherein the metal base is made of plastic steel to accommodate different thermal expansion coefficients at various locations.

6. The speed bump assembly as claimed in claim 1, wherein the metal base has multiple metal stubs to work at different locations.

7. The speed bump assembly as claimed in claim 6, wherein each stub on the metal base has an outer surface provided with at least one metal rib to increase the strength of combination between the metal stub and the road surface.

8. The speed bump assembly as claimed in claim 1, wherein the reflective feature is made of any possible material.

9. The speed bump assembly as claimed in claim 8, wherein the reflective feature reflects light to provide a reflective effect and is variable according to variation of the speed bump.
